(19) United States
(12) Patent Application Publication
(10) Pub. No.: US 2002/0125701 A1
(43) Pub. Date: Sep. 12, 2002

(54) Inflator for safety belt movable within inflator guide structure

(76) Inventor: Alex Devonport, Glendale, AZ (US)

Correspondence Address: Jerry J. Holden, Goodrich Corporation, 25401 N. Central Avenue, Phoenix, AZ, 85027, US

(21) Appl. No.: 10/079,585

(22) Filed: Feb. 22, 2002

Related U.S. Application Data
(63) Continuation-in-part of application No. 09/629,641, filed on Jul. 31, 2000, now abandoned.
(63) Continuation-in-part of application No. 09/703,552, filed on Nov. 1, 2000.
Application No. 09/703,552 is a continuation-in-part of application No. 09/099,858, filed on Jun. 18, 1998, now abandoned.

(51) Int. Cl. B60R 21/18

(52) U.S. Cl. 280/733

(57) ABSTRACT

An inflatable safety belt system having an inflatable torso section, an inflator, and a guide arrangement. An elongated housing holds the inflator and a portion of the inflatable safety belt while also allowing the inflator and belt to move along the elongated length of the housing. Skids, wheels, and other structures guide the inflator as it moves through the housing to prevent it from generating excessive frictional drag, unwanted noise, and vibration.

### RELATED APPLICATIONS

This application is a continuation-in-part of copending application Ser. No. 09/629,641, entitled “Inflator For Safety Belt Movable Within Inflator Guide Structure,” filed on Jul. 30, 2000, and a continuation-in-part of copending application Ser. No. 09/703,552, entitled “Belt System With Inflatable Section Within an Outer Belt Section And Method of Restraint,” filed on Nov. 1, 2000, which is a continuation-in-part of application Ser. No. 09/099,858, filed Jun. 18, 1998.

### TECHNICAL FIELD

The present invention is directed to an inflatable safety belt system with a portion of the safety belt housed in an enclosure having an inflator with a guide arrangement.

### BACKGROUND OF THE INVENTION

Belt systems including torso sections have been used in vehicular occupant protection in which one end of the torso section unwinds off a retractor reel during buckling up. A spring positioned in the reel urges the belt to rewind when the occupant unbuckles and releases the belt. The force of the spring must be overcome when buckling up.

Further, it has been suggested, such as in U.S. Pat. No. 5,851,055, that the torso belt be inflated by an inflator housed in an enclosure associated with the vehicle seat served by the belt system. In such an arrangement, the torso belt section, the inflator and a web belt section are tandemly connected for reciprocation in the enclosure. The web section is fed off a spring-loaded reel.

In these prior proposals, the inflator's exterior surface necessarily engages the interior of the enclosure as the inflator reciprocates in the enclosure during bucking, unbuckling, or adjustment of the seat belt. As a result of this contact, lateral movement of the inflator in the direction generally perpendicular to the desired direction of travel of the inflator may cause the inflator to rub or scrape along the enclosure walls causing frictional drag, noise, and vibration. As the possibility or occurrence of these problems increases, the significant benefit of providing greater protection to a passenger during a collision or accident that can be obtained with the use of an inflatable safety belt can become increasingly offset by these undesired features. Thus, it is desirable to have a system for an inflatable safety belt having, at most, a low likelihood of excessive frictional drag, unwanted noise, or vibration.

Furthermore, while some inflatable seat belt systems may initially adequately reduce the likelihood of excessive drag, noise, or vibration, not all configurations may be sufficiently durable to withstand repeated use over an extended period of time or high impact forces that the system may be subjected to either prior to or after assembly in a vehicle. Thus, it is also desirable to have a robust or durable system that can minimize the occurrence of excessive drag, unwanted noise, or vibration over an extended period or can withstand subjection to significant impact forces.

### SUMMARY OF THE INVENTION

Broadly, the present invention is directed to a vehicular torso safety belt that has minimal unwanted vibration or noise without excessive frictional drag. At least a portion of the belt and the inflator is housed and reciprocated in an enclosure associated with a seat. In general, the torso safety belt has a web portion and an inflatable torso portion that is in fluid communication with an inflator. In one embodiment, at least a portion of the inflatable torso belt surrounds or receives the inflator and the inflatable torso belt is sewn or otherwise attached to the web portion. Preferably, the inflator is enclosed within the inflatable torso belt. In another embodiment, the inflatable torso belt is tandemly connected to the inflator, which, in turn, is tandemly connected to the web portion. The web portion winds and unwinds from a retractor, which is preferably located at or near one end of the enclosure, while the inflatable torso portion moves in and out of the opposite end of the enclosure as it is pulled out during buckling of the seat belt, returned during unbuckling, or adjusted by the occupant. In one embodiment, the inflator inside the enclosure moves in a similar manner in response to buckling, unbuckling, or adjustment of the seat belt.

In a preferred embodiment, the inflator is positioned inside the enclosure and is equipped with a guide arrangement to guide the movement of the inflator as the torso safety belt is pulled further out or returned further in. If the inflator is positioned inside the inflatable portion, at least part of the guide arrangement may be secured to the inflator from the outside of the inflatable portion. The guide arrangement may assist in preventing the inflator from jamming or having excessive frictional drag while traveling through the enclosure. It also may reduce vibration and noise from the assembly as the inflator moves inside the enclosure or during operation of the vehicle. The guide arrangement engages the interior walls of the enclosure to reduce the likelihood of excessive frictional drag and to reduce the forces needed to pull the belt system into a buckled mode.

The guide arrangement may have wheels, skids, runners or other engagement members that have reduced areas of contact to further reduce excessive friction, noise, and vibration. The engagement members may also help to reduce the force required to buckle the belt system, as well as retract the web belt section back to the original arrangement when unbuckled.

In one embodiment, the wheels, skids, runners or other engagement members are attached directly to the inflator unit. In another embodiment, the engagement members are located on an inflator carrier that forms part of a guide arrangement. The inflator carrier may have flanges, hooks, holes and other surfaces, receptacles, or structures for the engagement members to be connected to it. In yet another embodiment, the engagement members are located on or form a part of the enclosure walls. In another embodiment, the engagement members are located on both the inflator (or its carrier) and the enclosure walls.

In one embodiment, the guide arrangement has a carriage with rollers that help the inflator travel through the enclosure. The enclosure may have tracks that receive the rollers, thereby further assisting in the desired travel of the inflator through the enclosure. In another embodiment, the guide arrangement has at least one spring that helps position the inflator. In one preferred embodiment using a spring, the spring material is connected to the guide arrangement, carrier, or inflator in at least two locations such that it forms a generally, or even substantially, arced or curved region of the spring that can flex or bend as forces are applied along the length of the spring material. Alternatively, a portion of the spring material may extend generally in a linear direction diverging from the inflator toward the enclosure wall.

In one embodiment, the spring material is connected by at least two points so that both ends of the arced or curved shape are connected to the guide arrangement, carrier, or inflator. The spring material may be configured and adapted to help resist permanent deformation of the spring material under high levels of forces or after remaining in a flexed or biased position for an extended period. For example, at least a portion of the spring material may be shaped to provide a substantially rigid support member that resists further deflection of the spring after a predetermined amount of deflection. Preferably, the support member resists further deflection along a portion of the arced or curved region of the spring. In an alternative embodiment, a portion of the spring material forming the arced or curved region can be configured to provide a similar support member.

In yet another, more preferred embodiment, the spring material may be connected to the inflator at only one end such that the spring acts as a cantilever when subjected to forces. The free end of the spring may be configured and adapted to help resist permanent deformation of the spring material under high levels of forces or under conditions where the spring material may deform from remaining in a flexed or biased position for an extended period of time. For example, the free end of the spring may be shaped to provide a support member for at least a portion of the arc or curve once the spring deflects a predetermined amount. In a preferred embodiment, the support member is shaped so that at least a portion of the spring material travels in a direction essentially the same as the direction of the impact loads or forces applied to it. When the spring is subjected to high impact loads, excessively high forces, or continued loads over an extended period, the support member helps resist permanent deformation of the spring material.

The spring may be connected to the inflator in any suitable way, although in a preferred embodiment the spring is connected to the inflator by rivets. In one variation of this embodiment, the spring material may be configured so that at least one end of the spring is slidably connected to the inflator. In this embodiment, the spring may slide as well as flex in response to applied forces.

### BRIEF DESCRIPTION OF THE DRAWINGS

FIG. 1A is a perspective view of a vehicle seat, a seat belt system according to one embodiment of the present invention, including enclosure and a seat belt arrangement in a buckled up state;

FIG. 1B is a rear perspective view of the seat belt system according to a tandem arrangement of the inflator, inflatable torso belt, and belt web about to be buckled about a passenger (not shown);

FIG. 2 is a perspective view of the belt system in its fully unbuckled state;

FIG. 3 is a perspective view similar to FIG. 1A with the belt system buckled up and the torso portion of the belt system inflated;

FIG. 4A is a partially enlarged front elevational view of the belt enclosure and associated parts except the guide arrangement;

FIG. 4B is a broken-away perspective view of that portion of the inflatable belt and inflator that resides in an enclosure;

FIG. 4C is a sectional view taken along line 4d-4d of FIG. 4B;

FIG. 4D is a cross-sectional side view of the inflatable torso belt portion and inflator prior to activation or the inflator;

FIG. 5 is a partial elevational view of the inflator positioned in the enclosure within a cradle with a wheeled guide arrangement;

FIG. 6 is a sectional view taken along line 6-6 of FIG. 5;

FIG. 7 is an alternative embodiment of the invention in which the inflator carries the legs and wheels;

FIG. 8 is a further embodiment in which the guide arrangement includes rails on the enclosure walls;

FIGS. 9A-9C illustrate several embodiments of guide arrangements with spring-loaded arms;

FIGS. 10A-10E illustrate several side views of spring material connected to a guide arrangement in at least two locations.

FIGS. 11A-11C illustrate several is a view of an inflator with a spring material connected thereto at one end.

### DESCRIPTION OF THE PREFERRED EMBODIMENTS OF THE INVENTION

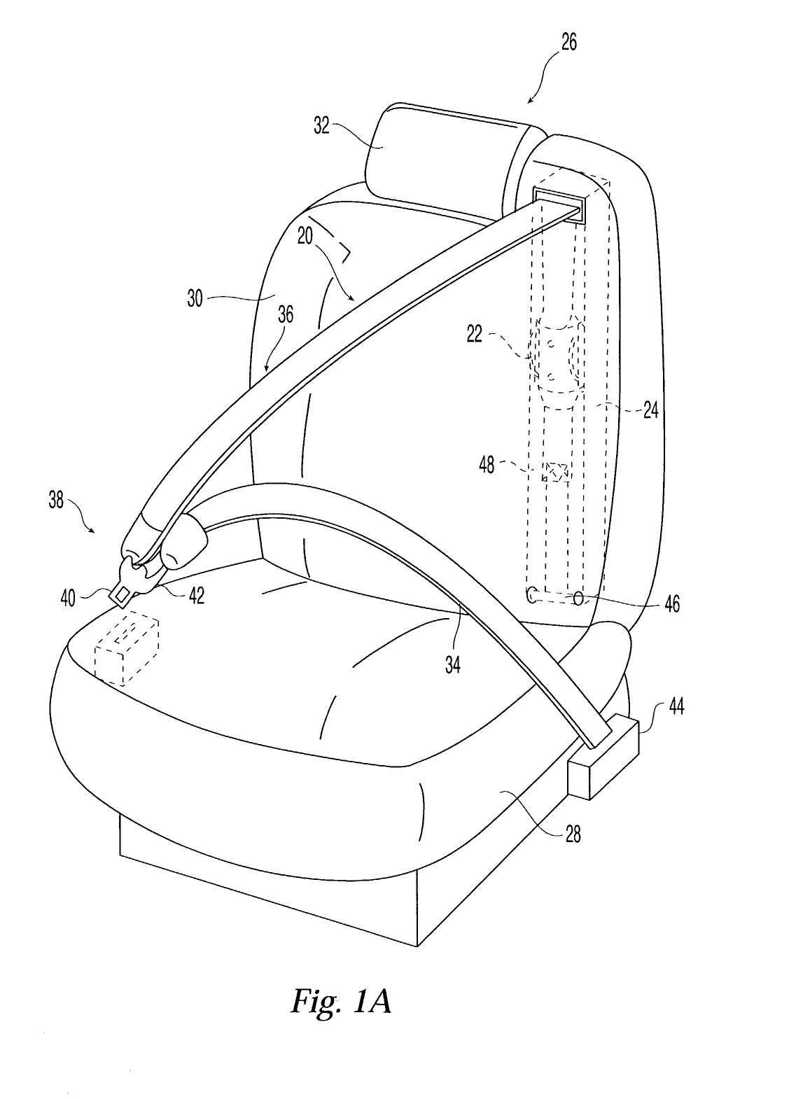

As stated above, the present invention is directed to an inflatable safety belt system 20 having an inflator 22 in fluid communication with an inflatable portion of the safety belt. As illustrated in FIG. 1A, vehicular seat 26 includes horizontal seat portion 28, seat back 30 and headrest portion 32. The safety belt system 20 includes lap belt section 34, an inflatable torso belt 36, and tongue unit 38. The inflator 22 and at least a portion of the inflatable safety belt are in housed within an enclosure 24. The enclosure helps guide the inflator 22 as the safety belt system 20 is bucked and unbuckled by an occupant. In addition, the enclosure 24 may be connected or anchored to a portion of the vehicle so that it can help securely position and hold the safety belt system 20 during deployment.

The belt system 20 may be selectively buckled or unbuckled in any suitable manner known to those skilled in the art. In the embodiment shown in FIG. 1A, tongue unit 38 includes tongue 40 and ring 42. As the belt system 20 is positioned over a passenger, lap belt section 34 pays out side take-up reel 44 and rear take up reel 46 allows the inflatable torso belt portion 36 to reciprocally move in and out of enclosure 24.

Preferably, as described below and illustrated in the figures, the torso belt 36 is inflatable. One end of the inflatable torso belt 36 is connected to a tongue unit 38 for buckling and unbuckling the belt system. In one embodiment, shown in FIG. 1A, the other end of the inflatable torso belt 36 is connected to a web belt 48 that is supplied by a rear take up reel 46. The inflator 22 is disposed inside the inflatable torso belt. In another embodiment, shown in FIG. 1B, the other end of the inflatable torso belt 36 is tandemly connected to the inflator 22, which, in turn, is tandemly connected to web belt 48. In a preferred embodiment, the web belt section 48 is not inflatable.

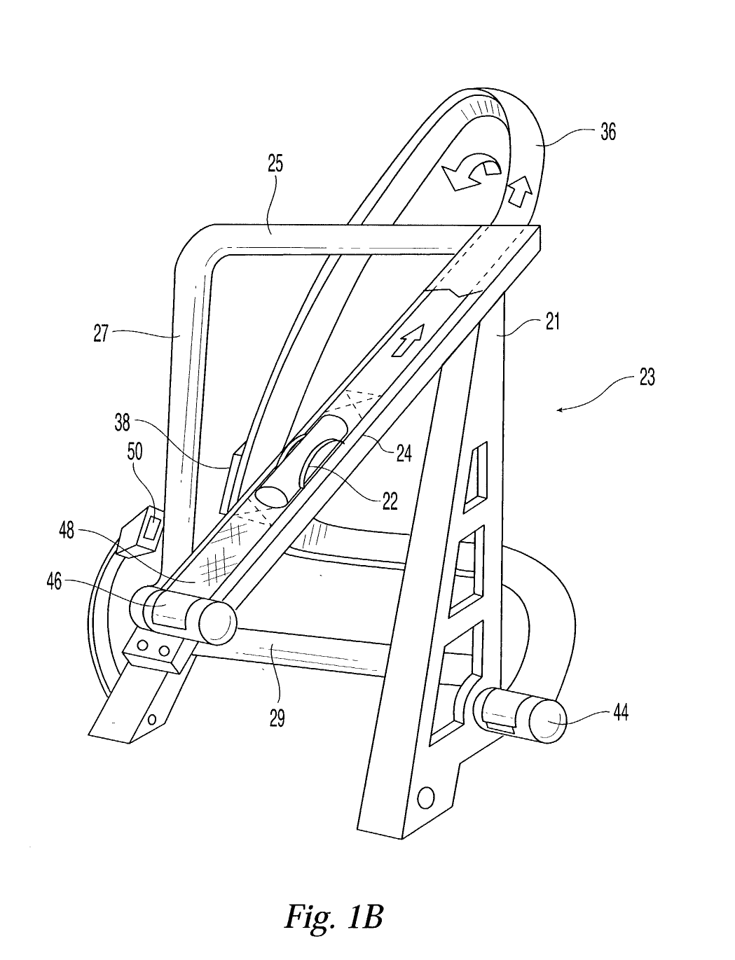

When the occupant buckles the belt system 20, the inflatable torso belt 36 is supplied out of the enclosure 24 across the torso of an occupant. At least a portion of the inflatable torso belt 36 resides outside of the enclosure 24 and a portion resides partially inside the enclosure in fluid communication with the inflator 22. When the belt system 20 is unbuckled, as shown in FIG. 2, at least part of the inflatable torso belt 36 returns inside the enclosure as the rear take reel 46 retracts web belt 48.

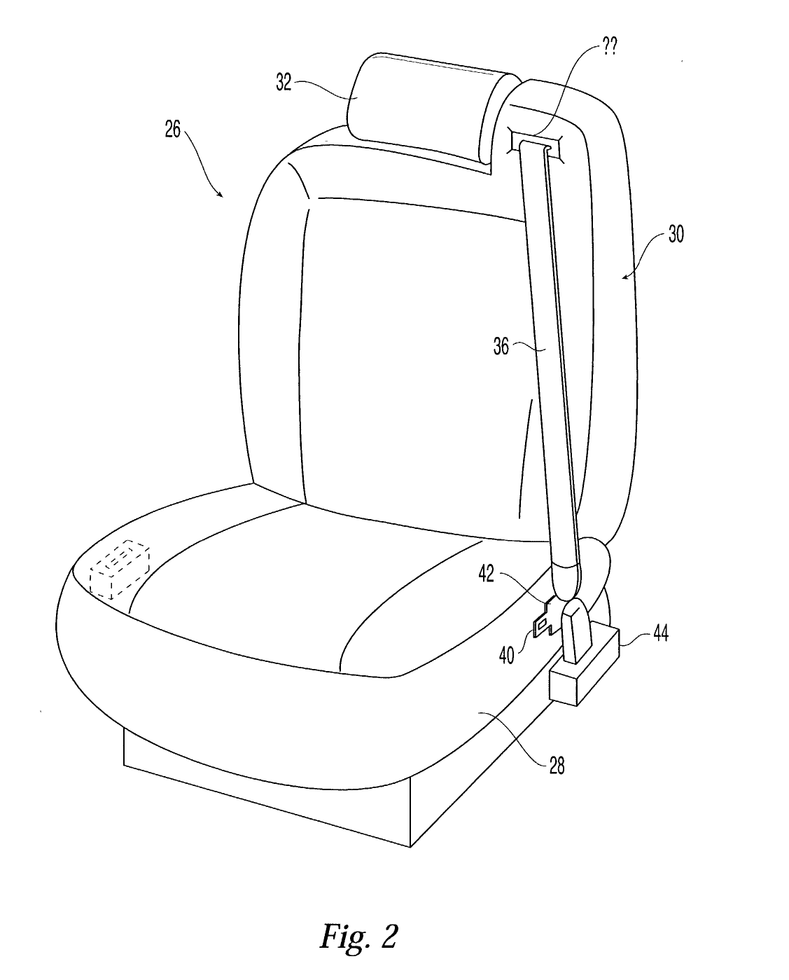

In the embodiment shown in FIGS. 1A and 3, the inflator 22 is at least partially located inside the inflatable torso belt 36 and more preferably, the inflator 22 is fully enclosed within the inflatable torso belt 36. For example, FIG. 3 depicts the inflatable torso belt 36 after deployment, or inflation, triggered by an event such as a vehicle collision, wherein the inflator 22 is situated within the inflatable torso belt 36. As shown, tongue unit 38 is connected to anchor 50 so that the inflatable torso belt 36 is positioned over the chest of the occupant. Thus, a first end of the torso belt 36 is secured in place by being fixedly connected, either directly or indirectly, to the tongue unit 38. The second end of the inflatable torso belt 36, which is in fluid communication with the inflator 22, can be anchored or secured to the vehicle in any suitable manner. Preferably, the second end of the inflatable torso belt 36 is secured to the web belt section 48, which, in turn, is anchored or secured to the vehicle via the rear take up reel 46.

In yet another embodiment, shown in FIG. 1B, the inflator 22 is tandemly connected to the inflatable torso belt 36 and the web belt 48. As shown, seat frame 23 of seat 26 (with the remainder of seat 26 not shown for illustrative purposes) includes A-frame upright 21, upright tubular frame piece 27, upper cross-piece 25, and lower cross-piece 29. Tongue unit 38 is reversibly connected to anchor 50 so that the inflatable torso belt 36 is positioned over the chest of the occupant. Thus, a first end of the inflatable torso belt 36 is secured in place by being fixedly connected, either directly or indirectly, to the tongue unit 38. The second end of the inflatable torso belt 36, which is in fluid communication with the inflator 22, can be anchored or secured to the vehicle in any suitable manner. Preferably, the second end of the inflatable torso belt 36 is in tandem connection with the inflator 22, which, in turn, is in tandem connection with one end of the web belt 48. A second end of the web belt 48 may be anchored or secured to the vehicle via the rear take up reel 46.

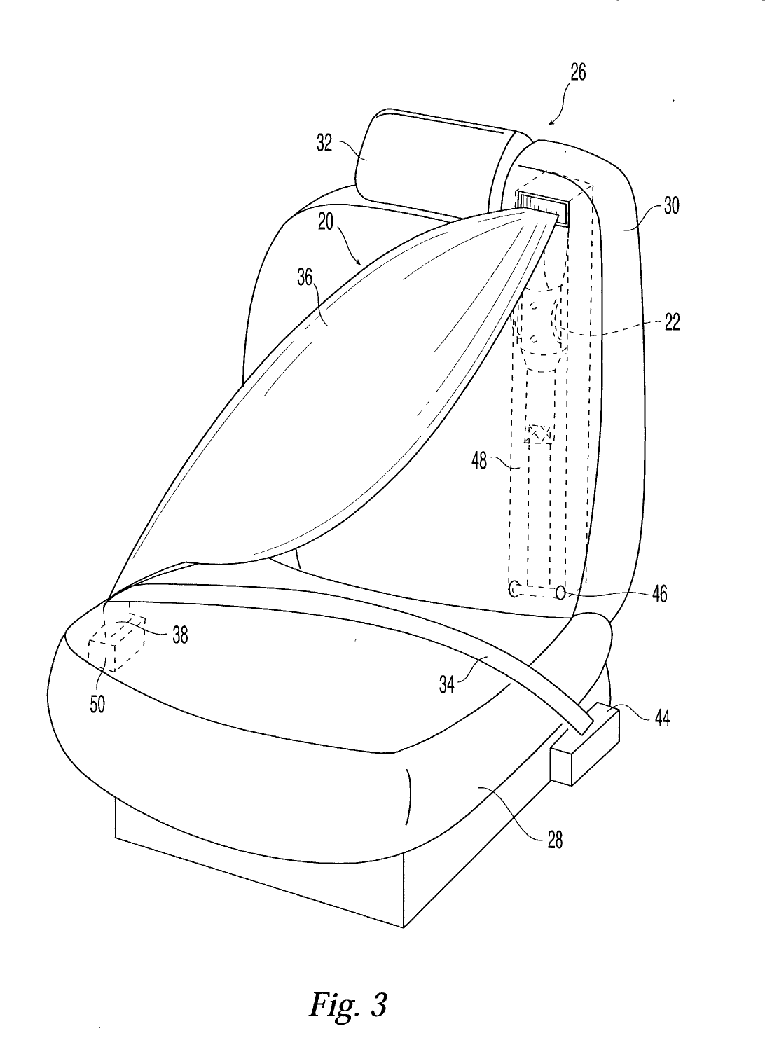

FIG. 4A shows an embodiment of the present invention where the inflatable torso belt 36 is inflated. During inflation, the portion of the inflatable torso belt 36 that is outside of the enclosure 24 will rapidly expand to provide protection to the occupant, while the portion of the inflatable torso belt 38 inside enclosure 26 is restrained by the size of enclosure. If the enclosure 24 is anchored or secured to the vehicle, it may assist in holding the safety belt system 20 in place after the inflatable torso section 36 has deployed. In such a case, the portion of the inflatable belt that is deployed within the enclosure 24 may assist in resisting forward movement of the passenger because the pressure between the inflated belt and the enclosure will provide frictional resistance to movement of the safety belt.

The inflatable torso belt section 36 of the safety belt may be constructed in a number of ways. For instance, the inflatable torso belt 36 may be constructed of a single layer of folded material joined along one edge of the belt. More preferably, however, the inflatable portion has multiple layers of material, one of which being a frangible cover or outer shell 52 that tears or bursts open upon inflation of at least one interior material 54 that is folded and stored within the outer cover until deployment. The diameter of the interior material 54 when fully inflated may be three to four times the width of the outer cover 52, although diameter to width ratios may also have ratios of five to one, six to one, or greater.

The inflator 22 is actuated to supply gases to the interior material 54 of the inflatable torso belt 36 in the first and earliest phase of a crash. As the gases start to inflate the interior material 54 of the inflatable torso belt 36, the resultant pressure presses the interior material outward against the outer cover 52 until the outer shell ruptures. After the cover 52 has ruptured, the interior material 54 rapidly expands outward from the ruptured area until the interior material is fully expanded. The outer cover 52 may have a frangible line that assists in controlling the length, location, and direction in which the outer cover 52 bursts open. Preferably, inflation of the torso belt 36 should be sufficient in diameter and length to push the occupant back in his or her seat, but not so large as to create a danger of injury.

As deceleration continues in later phases of the crash, the outer cover 52 may stretch in response to load forces by the occupant. At the same time the interior material 54 begins to pretension and foreshorten as it takes up an increasing portion of the load. As the interior material 54 inflates further, it takes more of the load while the outer cover 52 carries less of the load. When fully deployed, the interior material 54 may assume a significant portion of the load. In one embodiment, the interior material 54 is capable of handling from about 60% to about 90% of the load. Preferably, however, the interior material 54 and outer cover 52 share the crash load. This allows each material to be made thinner and lighter than conventional seat belt webbing material.

Further examples of the overall configuration, operation, and materials suitable for use with the safety belt system of the present invention are described in co-pending U.S. application Ser. No. 09/703,552 for “Belt System with Inflatable Section within an Outer Belt Section and Method of Restraint”, filed on Nov. 1, 2000, and also in U.S. Pat. No. 5,851,055, both of which are incorporated herein by reference in their entirety.

The enclosure 24 likewise may be constructed and configured in a wide variety of ways. For example, but without limitation to the following, the enclosure may be made of metal, plastics, polymers, or fiber reinforced materials. Regardless of the material used, it is desirable that the enclosure 24 be able to withstand inflation pressures and temperatures of gases emitted by the inflator 22 during deployment. In addition, it is also desirable for the enclosure 24 to provide adequate protection of the inflator 22 and other components of the system from exposure to potentially harmful elements or forces that may damage the inflator 22 or otherwise cause the safety belt system 20 to not function as desired. In addition, the enclosure 24 may have sound dampening, or friction-reducing coatings to assist in achieving the desired reduction in friction and noise during buckling, unbuckling, or adjustment of the safety belt system.

While the examples provided herein describe the enclosure 24 associated with a seat 26 or installed in the seat itself, it is also possible to position the enclosure 24 in other locations of the vehicle. For instance, for inflatable safety belt systems for the rear seat of an automobile, the enclosure may be located in the trunk of the vehicle. Additionally, the enclosure 24 may be located in a pillar of the vehicle, in the roof, or under the seat.

The inflator 22 contains a propellant composition that, when ignited, causes the inflatable torso belt 36 to rapidly expand. The term “inflator,” as used herein, and as known to those of ordinary skill in the art, may also be referred to as a gas generator. Suitable propellants for use in inflatable safety belts are available and known by those of ordinary skill in the art. Sensors and other controls installed in the vehicle may be utilized in order to control the timing and degree of deployment of the inflatable safety belt. The sensing system may consider, for example, the speed of the vehicle, passenger weight, the detection of an impending collision, rapid acceleration or deceleration of the vehicle, whether the safety belt system is buckled or unbuckled, or other driving conditions when determining when or how rapidly the inflatable safety belt should be deployed.

It is preferred that the inflator 22 is located within the enclosure 24 and may move along at least part of the length of the enclosure in response to adjustment or movement of the safety belt system, such as during buckling, unbuckling, or movement of the passenger. In one embodiment, shown in FIG. 4A, the inflator 22 is located inside the inflatable torso belt 36. The inflatable torso belt 36 is then connected to the web belt 48, such as by sewing or any other suitable technique known to those skilled in the art. In this embodiment, it is preferred that a guide arrangement 56, described in more detail below, is positioned around the inflator 22 on the outside of the inflatable torso belt 36.

Turning now to FIGS. 4B-4D, the inflatable torso belt section 36 includes an outer cover or shell 52 generally having a tubular belt construction and an interior material 54 that is folded for storage within the cover or shell prior to inflation. The cover 52 may be formed by weaving a tubular member that preferably has a cylindrical or oval cross-section. The interior material 54 as stored may have one or more folds 106 as illustrated in FIGS. 4B-4C. FIG. 4B illustrates a broken-away perspective view of a portion of an inflatable torso belt 36 within the enclosure 24, including a cross section of inflator 22.

FIG. 4C shows a sectional view taken along lines 4c-4c of FIG. 4B further illustrating one embodiment of the invention wherein the inflator is surrounded by both layers of the inflatable torso belt. The frangible cover 52 and interior material 54 are sewn or otherwise attached to the web belt 48, which in turn is secured to the vehicle in any suitable manner. Although not shown in FIG. 4C, a guide arrangement system 56 may be used to secure the inflator 22 to the inflatable torso belt 36.

While FIGS. 4B-4D show the inflator 22 located inside the materials that form the inflatable torso belt, the inflator 22 may also be tandemly connected to the inflatable torso belt 36 and the web belt 48.

The guide arrangement system 56, shown in FIG. 4D, may assist in reducing jamming of the inflator 22 inside the enclosure 24 and may also help reduce vibration and noise during operation of the vehicle. The configuration and arrangement of the guide arrangement system 56 can vary according to several considerations. Such considerations may include, but are not limited to, the shape or configuration of the enclosure 24, the desired level of resistance when a passenger buckles or unbuckles the safety belt system, and the desired degree of noise reduction or resistance to jamming. While several exemplary configurations are described more fully below, one skilled in the art would appreciate that many possible variations or alternative guide arrangement configurations would fall within the spirit and scope of the present invention.

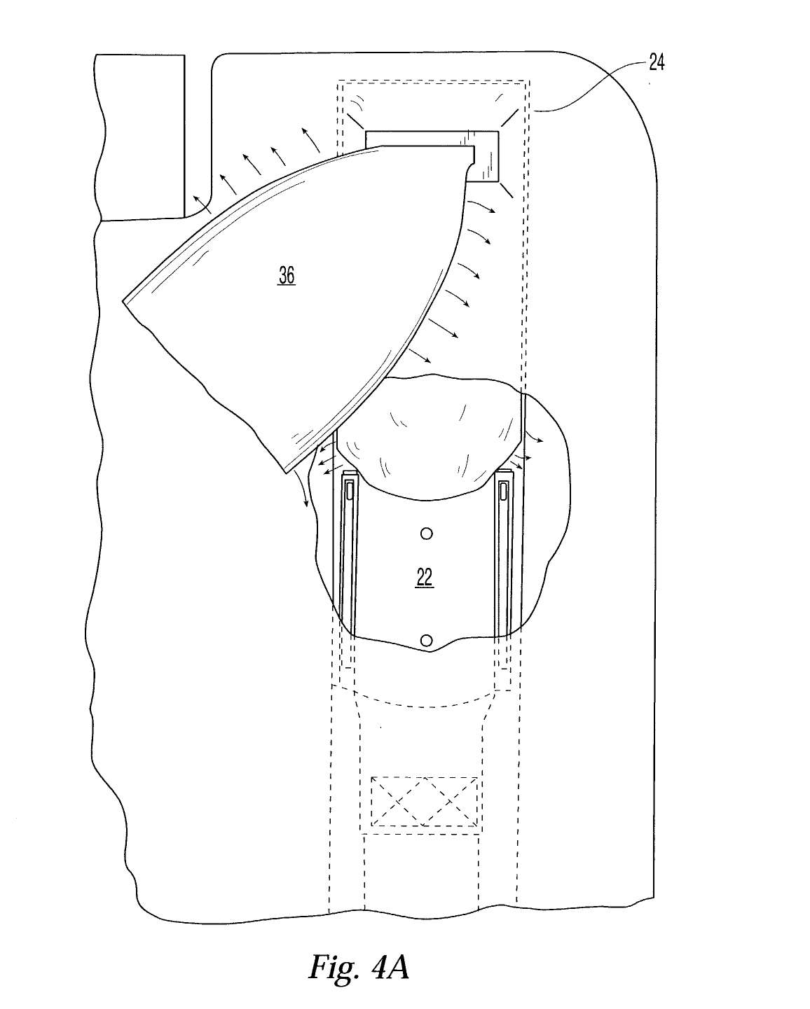

In one configuration shown in FIGS. 5-7, the guide arrangement system 56 has an inflator carrier 58 and wheels 60. The inflator carrier 58 may secure the inflator 22 to the inflatable torso belt 36 while also allowing the inflator to slide inside the enclosure 24 as the inflatable torso belt 36 is pulled out or returned by an occupant. Thus, while the position of the inflator 22 is fixed with respect to the torso belt 36, its position inside the enclosure 24 depends on the amount of the torso belt used by the occupant, which may vary with the occupant's size and shape. Although the inflatable torso belt 36 is not shown in these figures, the inflator 22 may be located inside the inflatable torso belt 36 as described above and as illustrated in FIGS. 4A-4D, or tandemly connected to the inflatable torso belt 36 and web belt 48, as illustrated in FIG. 1B.

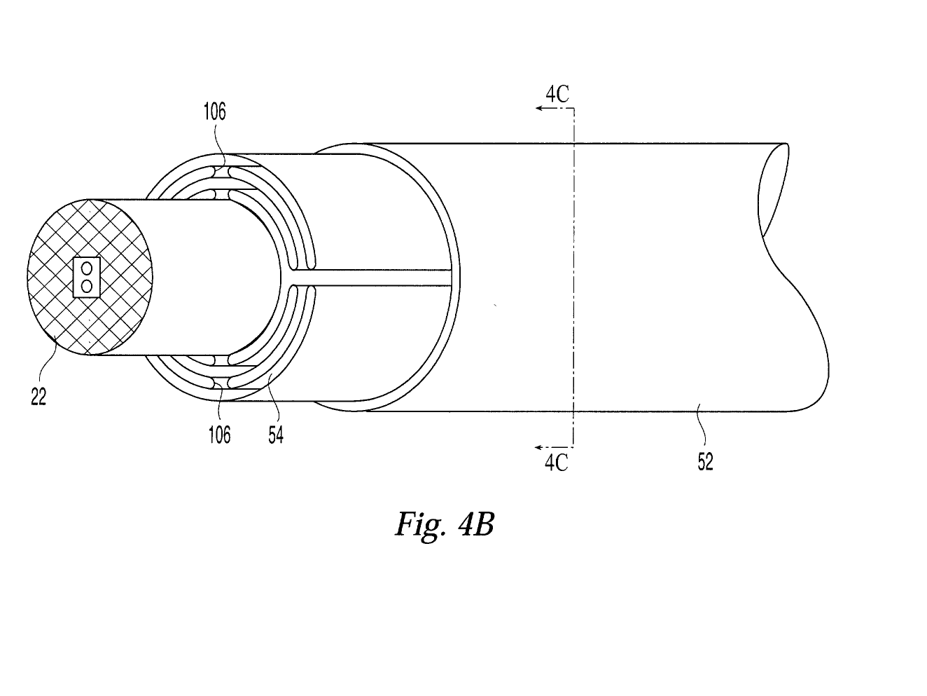

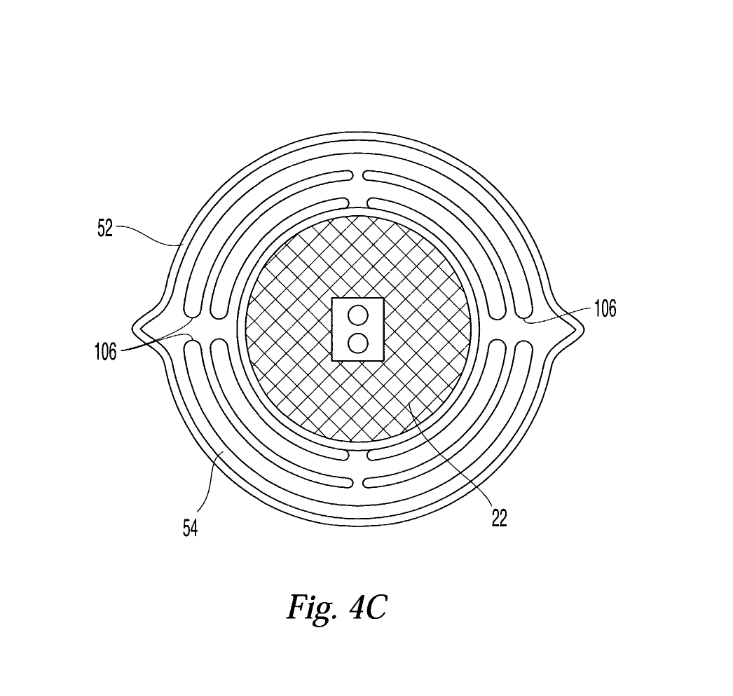

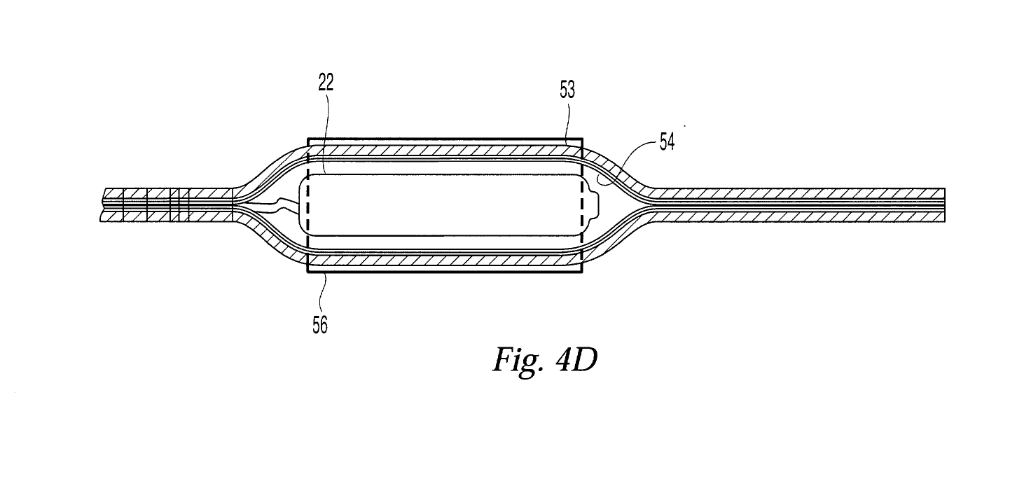

As shown, it is preferred that wheels 60 help maintain the position of the inflator 22 relative to the wall of the enclosure 24 by having the wheels roll in a channels, grooves, or tracks 62. As illustrated in FIGS. 6 and 7, the channels, grooves, or tracks may be formed by a portion of the walls of the enclosure 24. Placement of the wheels 60 near the upper and lower ends of the inflator 22, as shown in FIG. 5, further assists in preventing jamming of the inflator 22 as it moves inside the enclosure 24. FIG. 8 illustrates an alternative embodiment in which enclosure 24 has longitudinal rails 64. As described in other examples above, portions of the rails 64 in contact with the inflator carrier 58 may be coated with materials to help reduce noise or friction.

As discussed above, without the present invention the movement of the inflator 22 inside the enclosure 24 may result in excessive frictional forces from rubbing, scraping, or other engagement between inflator 22 and the walls of the enclosure 24. To reduce these frictional forces, the inflator 22 may have an inflator carrier 58 that has one or more legs 66 that help the wheels 60 contact the enclosure 24. The walls of the enclosure may have relatively flat portions 68 and curved portions 70.

As illustrated by the embodiment shown in FIGS. 5 and 6, the guide arrangement 56 may have eight (8) legs 66 with each leg having a wheel 60. The wheels 60 may be made of a compressible matter such as rubber to permit the inflator 22 and its guide arrangement 56 to move back and forth in the enclosure 24 without excessive resistance or binding due to inadequate clearance or excessive frictional forces. In one embodiment, the guide arrangement 56 comprises a generally cylindrical inflator carrier 58 with an opening into which an inflator 22 is force fitted or otherwise attached. Portions of the material used for the carrier 58 may be cut out or raised to accommodate wiring connected to the inflator 22. In one embodiment, the carrier 58 is cut out or raised to accommodate wiring connected to both the sensing system and the inflator 22.

The guide arrangement 56, legs 66, and wheels 60 are sized and proportioned so that inflator carrier 58 is spaced a slight distance from the walls of the enclosure 24. Preferably, the guide arrangement 56 positions the inflator 22 so that it is generally centered with respect to the cross section of the enclosure 24. One advantage of this arrangement is that it provides relatively uniform clearances for the inflator 22 and its associated guide arrangement 56 to allow the desired motion of the belt during adjustment by an occupant.

In actual operation, with one or more wheels 60 engaging certain enclosure surfaces 68 or 70, the non-engaging wheels may be spaced a small distance from other enclosure surfaces. In addition, the wheels 60 may be made of a compressible or elastomeric material so that compression of the wheel material may cause other wheels to disengage from the flat or curved surface of the enclosure.

For example, FIG. 6 shows wheels 60a engaging curved surfaces 70a while wheels 60b are slightly spaced from curved surfaces 70b. The clearance between the guide arrangement 56 and the path through which it travels in the enclosure 24 is small. In the embodiment shown in FIG. 6, wheels 60a and 60b may engage and roll on enclosure surfaces 70a and 70b, depending on the forces exerted on the guide arrangement 56 during reciprocation or movement within the enclosure, causing only a minor frictional resistance. The wheels 60a and 60b may be spaced such small distances from the wall surfaces 70a and 70b on which each rides or wheels 60 may be compressible to prevent binding.

Alternatively, legs 66 and wheels 60 can be attached directly to the inflator 22 (FIG. 7). The legs and wheels may be made flexible by sizing and proportioning the legs to assure contact with the wall-engaging end members of the legs and the enclosure 24. The wheels 60 also may be substituted by skids, runners, or the like. Other arrangements for reducing friction between the surfaces 68 and 70 and the inflator 22 may include protrusions from the inflator which slideably engage with or otherwise contact the enclosure as the inflator 22 moves inside the enclosure 24. These protrusions may have surface-engaging ends, or additionally may flex or bend in response to forces applied to the inflator.

FIG. 8 illustrates yet another alternative embodiment that includes an enclosure 24 having longitudinal rails 64 attached to the enclosure walls. The rails are shaped and positioned so that rail surfaces 74 facing toward the interior of the enclosure define a cross-sectional area (A) through which the inflator 22 passes as it reciprocates. While it is preferred that the rail surfaces 74 shown run substantially parallel to axis in which the inflator 22 travels, the rail surfaces also may run at angles to the axis of travel. Moreover, other guide arrangement structures may be used instead of rails, such as skids, runners, or the like, for the inflator 22 to ride on during its movement.

In a preferred embodiment, cross-sectional area (A) is cylindrically shaped and is slightly larger than the cylindrical shaped inflator 22. The inflator 22 defines a cross-sectional area (A′) which is slightly smaller than the cross-sectional area (A) defined by the rail surfaces 74. The difference between these areas (A-A′) provides a small clearance through which the inflator 22 may travel. In operation of the inflatable safety belt system, such small clearances help prevent misalignment and substantial movement of the inflator 22 in a direction perpendicular to the axis of its desired travel, thereby reducing substantial frictional drag.

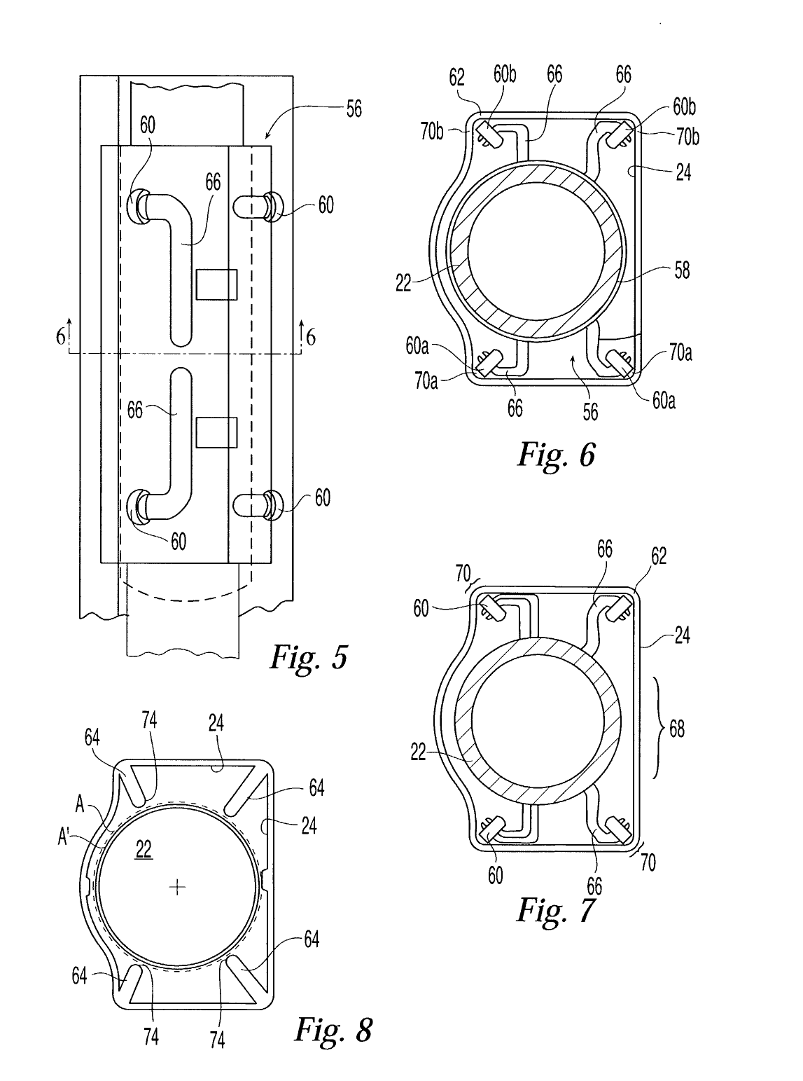

Various types of inflator carriers 58 are contemplated by the present invention. Several non-limiting examples are shown in FIGS. 9A-9C. In the illustrated embodiments, the inflator carrier is generally cylindrical in shape with a lower forward axle and wheel unit 76 and a lower rear axle wheel unit 78. The inflator carriers shown in these figures differ with respect to the upper arms 80 and the manner in which each is biased upwardly toward the flat or curved surface 68 or 70 of the enclosure 24.

In one embodiment, shown in FIG. 9A, inflator carrier 58 has four upper arms 80 that pivot or rotate about pivot pins 82. The upper arms 80 preferably carry wheels 60, though other reduced frictional arm ends previously described herein also may be used. In the embodiment shown, the portion of the enclosure 24 that may contact the wheels 60 is a flat surface 68. Upper arms 80 are urged upwardly against the enclosure surface 70 by springs 84. The springs may have any configuration (i.e. coiled spring, leaf spring, etc.) suitable for providing the desired biasing force to the upper arms 80. The spring may be made of any suitable material. For instance, it may be made of metal (e.g. spring steel), of an elastomeric polymer, or of a flexible container having a compressible gas sealed inside.

In another embodiment, shown in FIG. 9B, the inflator carrier 58 has two V-shaped upper arms 80 on each side of the inflator carrier. Preferably, the V-shaped upper arms 80 are made of spring steel. The V-shaped upper arms 80 pivot about pivot pins 82. In this embodiment, the V-shaped upper arms 80 may pivot so that at least one side of the arms contacts the enclosure 24. The arms also may flex or bend in response to applied loads so that both sides of the arms contact the enclosure 24.

In yet another embodiment, shown in FIG. 9C, the inflator carrier 58 has four upper arms 80 that pivot about pins 82 in a manner similar to the embodiment shown in FIG. 9A. In addition, coil springs 86 urge the upper arms 80 against an enclosure wall (not shown).

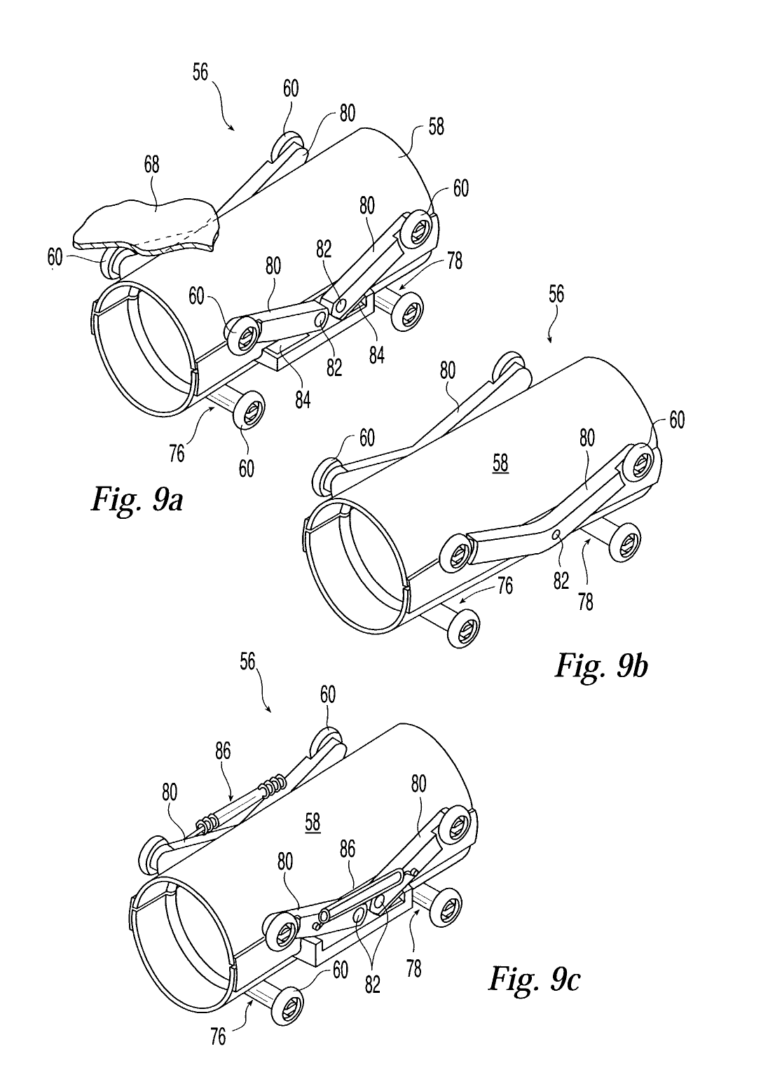

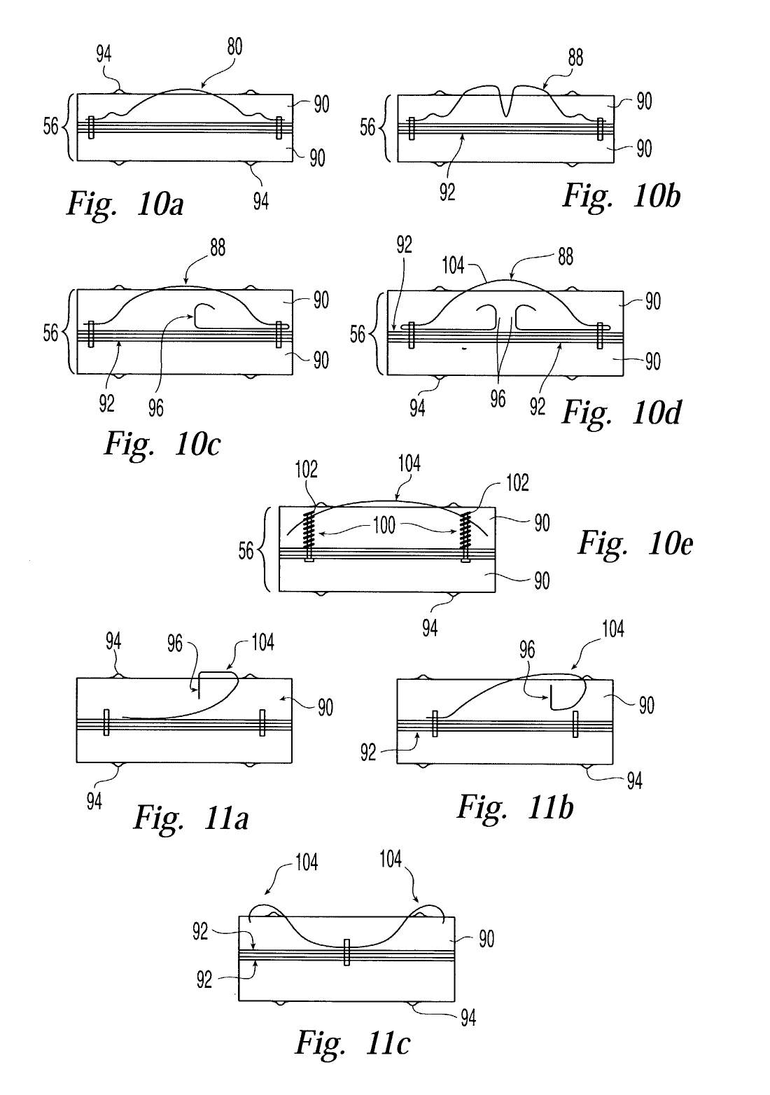

As previously discussed, other structures also may be used to provide the desired engagement with the enclosure 24 and feel or performance during movement of the inflator 22 by an occupant. Some examples of this embodiment are illustrated in FIGS. 10A-10E and 11A-11C, which are described in greater detail below. For instance, other guide arrangements may use skids instead of wheels so that the inflator 22 is slideably positioned in the enclosure 24. The skids may be made of spring material 88 that flexes or bends under application of force, but generally returns to its original shape once the force is removed. Materials such as these are widely available, known to those of ordinary skill in the art, and may include metallic materials, polymers, open or closed cell foams, or the like.

The spring material 88 may be connected to a guide arrangement 56, to an inflator carrier 58, to the inflator 22, or to any other structure associated with the enclosure 24 or the inflator. Preferably, the spring material 88 is connected to an inflator carrier 56 that helps hold the inflator 22 in place within the enclosure 24. In order to facilitate installation of the spring material 88, the carrier, inflator, or guide arrangement may have holes, slots, hooks, flanges, or any other suitable structure.

In one embodiment, the inflator carrier 58 is made of two sections 90 having a generally semi-circular cross section and flange surfaces 92 that, when the two sections 90 are joined around an inflator 22, face a corresponding flange surface from the opposing section. The flange surfaces 92 may have holes or slots through which the spring material 88 may be attached. The spring material also may be riveted to the flange surface 92 or adhered thereto with an epoxy. When joined, the holes or slots on the flanges 92 preferably match with corresponding holes or slots from the opposing section 90. Rivets, screws, or fasteners of any type may be used to securely hold the guide arrangement 56 or inflator carrier 58 around the inflator 22. It is preferred that the fastener used to join the two sections of the carriage or guide arrangement also be used to connect the spring material to the rest of the assembly.

The two sections 90 also may be configured to have at least one protrusion 94, but more preferably at least two, that face out toward the inside wall of the enclosure 24. When fully assembled inside an enclosure, the protrusions 94 on one side of the carrier 56 or guide arrangement 58 contact the inside wall of the enclosure. The protrusions cause the springs 88 on the opposite side of the carrier or guide arrangement to contact the enclosure as well, thereby positioning the inflator 22 in the enclosure 24 in a manner that minimizes the potential disadvantages described above. In an alternative embodiment, similar to those described above, the distance between the outermost edge of the protrusion 94 and the outermost edge of the spring 88 is slightly less than the distance between the contact surfaces of the enclosure 24.

Several exemplary embodiments of the present invention are illustrated in FIGS. 10A-10E In these illustrated embodiments, the spring material 88 is connected to a flange surface 92 of the inflator carrier 58 in at least two locations. In general, at least a portion of the spring material extending between these two connections may have an arced or curved side view. As illustrated in FIG. 10A, portions of the curvature of the spring material 88 near where it is connected to the inflator carrier 58 may alternate from convex to concave. When viewed from the side, a portion of the spring should extend beyond the outermost edge of structures that form the inflator, carriage, and guide arrangement. As mentioned above, this portion of the spring provides slideable engagement between the inflator 22 and the enclosure 24.

It is preferred that the spring material 88 be configured to be resistant to permanent deformation that may result from high forces, such impact forces that may result from inadvertently dropping the enclosure and ignitor before it is installed, or from deformation that may occur if the spring 88 is maintained in a flexed or biased position for an extended period of time. It is preferred that the spring 88 be shaped to have a supporting member 96 that helps resist such deformation.

FIGS. 10B-10D illustrate some non-limiting examples of how a portion of the spring material 88 may be shaped to provide a supporting structure 96. FIG. 10B, for instance, shows a spring material 88 having a generally arched or curved shape, but having an additional downward curvature of the spring material near the middle of the spring. The lowest portion of this downward curvature contacts the flange surface 92 of the inflator carrier 58 when the spring deflection exceeds a predetermined amount. As shown in FIGS. 10C and 10D, the ends of the spring material 88 may be directed underneath the arced or curved shape and directed upwards toward the bottom side of the spring. Once again, when the spring deflects beyond a predetermined distance, the supporting member 96 resists further deflection of the spring 88. This additional resistance helps prevent the spring from being deflected to the point where it would be permanently deformed.

Another embodiment, shown in FIG. 10E, shows a skid 98 made of spring material that is protected from excessive deflection. In this example, the skids 98 are connected to the rest of the assembly by spring-loaded fasteners 100 that allow the skid 98 to move downward when forces are applied to it. In one embodiment, the spring-loaded fasteners have posts 102 that may engage with the enclosure 24 if movement of the inflator carrier 56 exceeds a predetermined amount. In addition to the springs associated with the fasteners, the skids themselves also may be made of spring material so that the generally arced or curved shape may flex in response to the applied forces.

Turning to FIGS. 11A-11C, it is preferred that the spring 88 is be connected to the inflator, carrier 58, or guide arrangement 56, at only one end. In this embodiment, the spring 88 deflects more freely than springs having two or more connections in response to the forces applied to it. As described above, the spring material 88 once again may be curved or shaped to have a supporting member 96 resisting deflection of the spring beyond a predetermined distance. Preferably, at least a portion of the supporting member 96 travels in a direction approximately perpendicular to the direction that the inflator 22 travels when the safety belt is pulled out of or returned to the enclosure. That is, the supporting member 96 preferably is configured so that it resists movement perpendicular to the elongated axis of the enclosure 24.

In the preferred embodiment of FIG. 11A, the spring 88 gradually increases in distance from the rest of the assembly until the material extends beyond the upper-most portion of the assembly when viewed from the side. The material the sharply turns to form a first end of a contact surface 104 of the spring that slideably engages with the enclosure 24. Preferably, the contact surface 104 is gently arced or curved. After the contact surface, the spring material then sharply turns toward the flange to form a support member 96. Preferably, at least a portion of the support member 96 travels approximately in the direction as the forces or impact loads it will help resist.

FIG. 11B utilizes a similar spring construction as described above with the exception that the curvature of the spring approximately between the connection and the contact surface is reversed. One skilled in the art would readily appreciate that the curvatures and shapes described in these two examples are not limiting and that several variations would be possible without departing from the spirit and scope of the invention.

FIG. 11C shows yet another embodiment of the invention where the spring 88 has only a single connection. Instead of connecting the spring near one end, however, it is connected near the middle so that the spring material on each side of the connection can slideably engage with the enclosure 24.

Operation of the inflatable safety belt system 20 may be better understood with reference to FIGS. 1 and 3-4, however, the embodiment depicted therein are not intended to limit use of the invention to that embodiment. An occupant sits in the vehicle seat 26, pulls the tongue unit 38 over his or her lap, and inserts the tongue 40 in the buckle receiver. The web belt 48 is supplied by the rear take up reel 46 as part of the inflatable torso belt 36 is pulled out of the enclosure 24. The safety belt system 20 is designed so that the inflator 22 and at least a portion of the inflatable torso belt 36 remain in the enclosure 24 even when the largest occupant is being accommodated. The guide arrangement 56 assists in the payout and return of the torso belt with reduced frictional drag or propensity to become jammed. Springs 84, wheels 60, or similar structures may be used to reduce vibrational noise during operation of the vehicle.

During a crash event when the vehicle experiences rapid deceleration or rapid acceleration, a crash sensor (not shown) activates the inflator 22 which discharges gases into the inflatable torso belt 36. The rear retractor reel 46 and the side retractor reel 44 lock up preventing any additional belt pay out. Since the inflator 22 and part of the inflatable torso belt 36 are located in the enclosure 24, the gases first discharged from the inflator 22 expand the interior material 54 of the inflatable torso belt 36 within the confines of the enclosure 24. The portion of the interior material 54 located inside the enclosure 24 is at least partially restrained from full expansion by the walls of the enclosure 24.

The discharged gases will also inflate the portion of the inflatable torso belt 36 outside of the enclosure 24. Pressure will build up in the inflatable torso belt 36, thereby causing the outer cover or shell 52 to rupture. The rupture begins at the weakest point and then rapidly tears or ruptures along the longitudinal length of the outer cover or shell 52. Once inflated, the inflatable torso belt 36 provides increased protection to the passenger during the collision while continuing to restrain movement of the occupant.

Finally, it is to be understood that the invention is not to be limited solely to the exact configurations or embodiments illustrated and described herein. The embodiments discussed in the Detailed Description of the Invention are not intended to limit the invention. Accordingly, all expedient modifications or combinations readily attainable by one of ordinary skill in the art from the disclosure set forth herein, or by routine experimentation therefrom, are deemed to be within the spirit and scope of the invention as defined by the appended claims.

What is claimed is:

1. An inflatable safety belt comprising:
an inflatable torso belt having a portion disposed within an enclosure;
an inflator disposed within a first end of the inflatable torso belt, wherein said inflator is in fluid communication with the inflatable torso belt;
a webbing connected at a first end to the first end of the inflatable torso belt, wherein a second end of the webbing is associated with a retractor; and
a guide arrangement, wherein the guide arrangement is secured around the inflator and a second portion of the inflatable torso belt and slideably disposed within the enclosure.

2. The inflatable safety belt of claim 1, wherein the guide arrangement further comprises a spring member secured to the guide arrangement at a first and second location, and wherein a portion of spring material between the first and second location forms a curved region approximately in the form of an arc.

3. The inflatable safety belt of claim 2, wherein the spring member can flex in response to forces applied along its length.

4. The inflatable safety belt of claim 3, wherein the guide arrangement further comprises a support that resists further flexing of the spring member after flexing a predetermined distance.

5. The inflatable safety belt of claim 1, wherein the guide arrangement further comprises a spring member secured to the guide arrangement at a first location, and wherein a free end of the spring material is biased against the elongated enclosure.

6. The inflatable safety belt of claim 5, wherein the spring member can flex in response to forces applied along its length.

7. The inflatable safety belt of claim 6, wherein the guide arrangement further comprises a support that resists further flexing of the spring member after flexing a predetermined distance.

8. The inflatable safety belt of claim 7, wherein the spring member is connected to the guide arrangement by at least one rivet.

9. A system for protecting a passenger in a vehicle during a collision comprising:
an occupant seat;
an inflatable belt;
an elongated enclosure associated with the occupant seat;
an inflator in fluid communication with the inflatable belt, wherein the inflator is housed within the elongated enclosure and may move in the elongated direction of the enclosure; and
an inflator guide arrangement, wherein the guide arrangement allows the inflator to move within the elongated enclosure without substantial frictional forces or interference between the inflator unit and the enclosure.

10. The system of claim 9, wherein the guide arrangement is associated with the inflator and comprises at least one engagement member that prevents substantial movement of the inflator in a direction perpendicular to the elongated axis of the enclosure.

11. The system of claim 9, wherein the enclosure has at least one engagement member that prevents substantial movement of the inflator in a direction perpendicular to the elongated axis of the enclosure.

12. The system of claim 9, wherein the guide arrangement further comprises a wheeled assembly associated with the inflator.

13. The system of claim 12, wherein the enclosure comprises a plurality of walls that form corners, and wherein the wheeled assembly contacts the enclosure.

14. The system of claim 13, wherein the plurality of walls meet at substantially right angles.

15. The system of claim 11, wherein the engagement member comprises a spring-loaded arm.

16. The system of claim 10, wherein the engagement member comprises an arm with a wheel, wherein the arm is urged against the elongated enclosure interior wall by springs.

17. The system of claim 16, wherein the arm comprises a spring material.

18. An inflatable safety belt system comprising:
an occupant seat;
an inflatable safety belt:
an inflator in fluid communication with the inflatable safety belt;
an elongated enclosure associated with the seat and having an interior wall surface, wherein the inflator is housed within the elongated enclosure and may move in the elongated direction of the enclosure; and
reduced friction members on the enclosure interior wall surface define a pathway through which the inflator unit passes as it reciprocates, wherein the pathway is slightly larger in cross section than the cross section of the inflator.

19. An inflatable safety belt comprising:
an inflatable torso belt having a portion disposed within an enclosure;
a webbing connected at a first end with a retractor;
an inflator in fluid communication with the inflatable torso belt; and
a guide arrangement, wherein the guide arrangement is secured around the inflator and slideably disposed within the enclosure.

20. The inflatable safety belt of claim 19, wherein the inflator is disposed between the inflatable torso belt and a second end of the webbing.

21. The inflatable safety belt of claim 20, wherein the guide arrangement further comprises a spring member secured to the guide arrangement at a first and second location, and wherein a portion of spring material between the first and second location forms a curved region approximately in the form of an arc.

22. The inflatable safety belt of claim 21, wherein the spring member can flex in response to forces applied along its length.

23. The inflatable safety belt of claim 22, wherein the guide arrangement further comprises a support that resists further flexing of the spring member after flexing a predetermined distance.

24. The inflatable safety belt of claim 20, wherein the guide arrangement further comprises a spring member secured to the guide arrangement at approximately a first location, and wherein a free end of the spring material is biased against the elongated enclosure.

25. The inflatable safety belt of claim 24, wherein the spring member can flex in response to forces applied along its length.

26. The inflatable safety belt of claim 25, wherein the guide arrangement further comprises a support that resists further flexing of the spring member after flexing a predetermined distance.

27. The inflatable safety belt of claim 26, wherein the spring member is connected to the guide arrangement by at least one rivet.

28. The inflatable safety belt of claim 20, wherein the inflator is disposed within the portion of the inflatable torso belt disposed within the enclosure.
